(19) United States
(12) Patent Application Publication
(10) Pub. No.: US 2004/0030989 A1
(43) Pub. Date: Feb. 12, 2004

(54) System and method for creating and organizing on-line content

(75) Inventors: David J. Samuels, New City, NY (US); Oleg Arsky, Shenorock, NY (US)

Correspondence Address: MORGAN LEWIS & BOCKIUS LLP, 1111 PENNSYLVANIA AVENUE NW, WASHINGTON, DC, 20004, US

(73) Assignee: Zoologic, Inc.

(21) Appl. No.: 10/615,935

(22) Filed: Jul. 10, 2003

Related U.S. Application Data
(60) Provisional application No. 60/401,893, filed on Aug. 9, 2002.

(51) Int. Cl. G06F 17/00

(52) U.S. Cl. 715/500

(57) ABSTRACT

A system for quickly retrieving information that is related to a specific topic. Information from the system is delivered through a standard web. The on-line reference tool includes multiple components and information that is structured into multiple units such that each unit is related to a specific topic. The on-line reference tool links related units of information that teach a specific subject (teaching objects) to terms in the system's glossary. An editor writes at least one question that corresponds to each link from the glossary to the teaching object. Thereafter, when a user selects a question, at least one unit of information (teaching object) associated with the glossary term is presented to the user.

This application claims the benefit of U.S. Provisional Application No. 60/401,893 filed on Aug. 9, 2002.

### FIELD OF THE INVENTION

The present invention relates to a system and method for creating and organizing on-line content, and more particularly, relates to a system and method for providing fast and accurate access on-line content.

### BACKGROUND OF THE INVENTION

Some corporations provide education to their employees through on-line courses. These courses include a finite amount of information that is typically arranged in a predefined order, for example, in the form of a book with sections, chapters, and pages. Although an employee taking such courses is able to link between sections, to reference information about a specific question, the employee typically spends considerable time going through large portions of course materials. For example, the employee may have to read several pages in one chapter to find the information that is related to the specific question. This reduces the employee's productivity. Therefore, some corporations are interested in a quicker and more efficient manner of allowing their employees to reference information that is related to a specific question/topic.

Current computer networks, particularly those on the Internet, have access to online search engines that search large amounts of information for specific terms. These search engines typically search large amounts of unstructured content and retrieve all information that include a specific term, whether or not the retrieved information is relevant to the search term. As a result, most of the information retrieved by these search engines is irrelevant to the employee. For example, if the employee uses a current search engine to search for information relating to swimming pool installation and the employee enters “pool installation” into the search engine, the search engine may retrieve, among other information, information relating to installing swimming pools, information relating to office pools, and information relating to billiards. The employee must then manually review all retrieved information to find information that is relevant to swimming pool installation. This also reduces the employees' productivity.

Innovative products and structures are therefore needed to increase the accuracy of retrieving relevant information that is related to a specific search term. Moreover, what is needed is an efficient manner for rapidly referencing information that is related to a specific question from a finite amount of materials.

### SUMMARY OF THE INVENTION

The present invention relates to a system for quickly retrieving information that is related to a specific topic. Information from the system is delivered to an end user through a standard web browser. The on-line reference tool includes multiple components and information that is structured into multiple units such that each unit is a teaches a specific subject and is associated with a specific topic. The on-line reference tool links related units of information to glossary terms in the inventive system. An editor writes at least one question that corresponds to each link from the glossary to the units of information. Thereafter, when a user selects a question, the appropriate unit of information associated with the glossary term is presented to the user.

Specifically, the on-line reference tool in the inventive system includes a repository of question links, multiple teaching objects, a glossary, and all the relevant information needed to organize and categorize the glossary and teaching objects. The teaching object materials come from at least one source and is structured in multiple pages, each page being one teaching object. Each teaching object is related to multiple glossary terms and each glossary term is related to multiple teaching objects. Each teaching object teaches a specific concept and may be hyper-linked to other multiple related teaching objects. The glossary includes multiple glossary terms that are associated with a given topic; multiple glossary definitions, each of which defines a specific glossary term; multiple glossary aliases, each of which is an alternate name for a specific glossary term. Teaching objects may also contain multiple glossary links, each of which links the teaching object to an appropriate glossary term and glossary definition.

The on-line reference tool also includes means for allowing the user to enter a term in a lookup form; means for searching the content for the term and producing a list of terms, at least one definition for each term, and at least one question for each term that is linked to a teaching object; means for enabling the user to select one term from the list of terms and a question and an associated answer; and means for displaying a unit of information that contains the associated answer.

The invention also relates to a method of structuring information that is related to a specific topic so that the structured information can be organized to be searched and presented to a user. Content is structured by breaking it up into multiple pages or teaching objects; sequencing the pages from basic to complex; associating each page with a unique identifier; linking related pages using hyper-links; extracting all glossary terms, associated definitions and aliases that are relevant to the specific concept from each teaching object; searching all teaching object for all relevant glossary terms and aliases; using the teaching object identifier to produce a hyper-referencing table that links every glossary term to an appropriate teaching object; filtering each reference in the hyper-referencing table for relevance and writing a corresponding question for each relevant reference; and storing a modified hyper-referencing table that includes at least one corresponding question, wherein when the user selects a question that is related to a specific term, the appropriate teaching object is presented to the user.

Additional features and advantages of the invention will be set forth in the description that follows, and in part will be apparent from the description, or may be learned by practice of the invention. The objectives and advantages of the invention will be realized and attained by the system and method particularly pointed out in the written description and claims hereof as well as the appended drawings.

### BRIEF DESCRIPTION OF THE DRAWINGS

The accompanying drawings, which are included to provide a further understanding of the invention and are incorporated in and constitute a part of this specification, illustrate embodiments of the invention that together with the description serve to explain the principles of the invention. In the drawings

FIG. 1 illustrates a local area network that includes an on-line reference tool for efficiently retrieving relevant information that answers specific questions in accordance with the principles of the invention;

FIG. 2 illustrates the on-line reference tool that provides information to users by creating granular areas of content that are rapidly accessible through lookups, indices, and links in accordance with the principles of the invention;

FIG. 3 illustrates how pages from content in the on-line reference tool are structured;

FIG. 4 illustrates an embodiment of the on-line reference tool that is presented to the user;

FIG. 5 illustrates an example of how elements in FIG. 4 are implemented;

FIG. 6 illustrates examples of questions that may be produced by the on-line reference tool for a specific term; and

FIG. 7 illustrates the steps implemented in the inventive system.

### DESCRIPTION OF PREFERRED EMBODIMENTS

Reference will now be made in detail to the preferred embodiments of the present invention, examples of which are illustrated in the accompanying drawings. The present invention described below extends the functionality of the inventive system and method for using an on-line reference tool to quickly retrieve information that is related to a specific question in accordance with the principles of the invention.

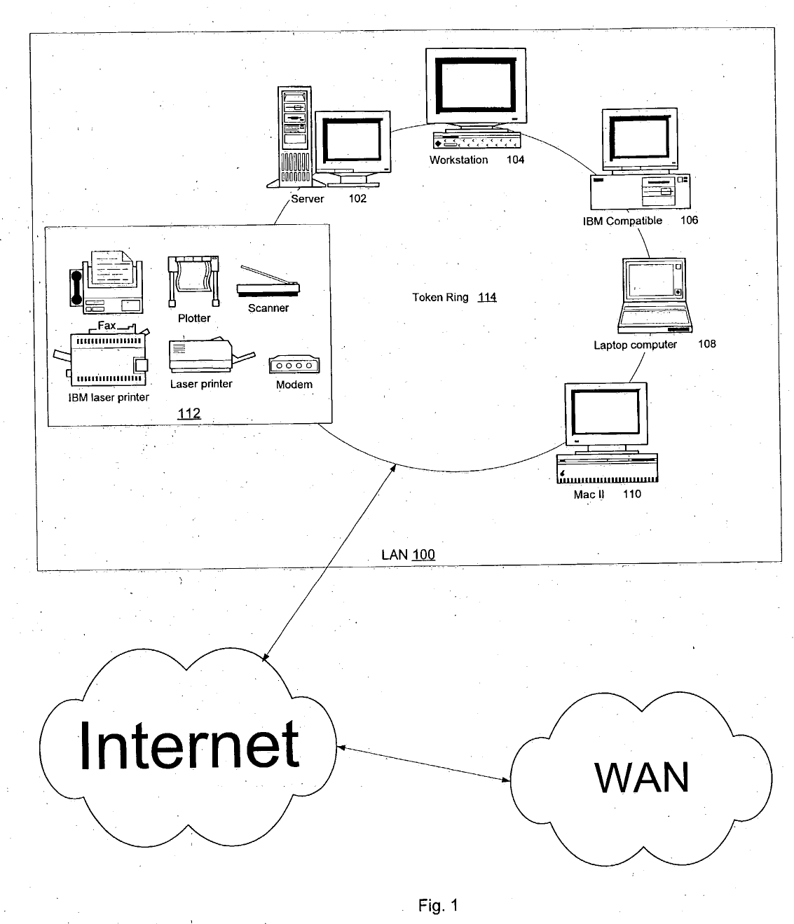

FIG. 1 illustrates a local area network (LAN) 100 that includes an on-line reference tool for efficiently retrieving relevant information that answers a specific question. LAN 100 comprises a server 102, four computer systems 104, 106, 108 and 110, and peripherals, such as printers and other devices 112, that may be shared by components on LAN 100. Computer systems 104, 106, 108 and 110 may serve as clients for server 102 and/or as clients and/or servers for each other and/or for other components connected to LAN 100. Components on LAN 100 are preferably connected together by cable media, for example, copper or fiber-optic cable and the network topology may be a token ring topology 114. It should be apparent to those of ordinary skill in the art that other media, for example, wireless media, such as optical and radio frequency, may also connect LAN 100 components. It should also be apparent that other network topologies, such as Ethernet, may be used.

According to the invention, LAN 100 is connected to the Internet and may be connected to other LANs or Wide Area Networks (WAN). Hence some components of LAN 100 are preferably Web-enabled. The computer processors used to execute the inventive system and method, for example server 102 and/or computer systems 104, 106, 108 and 110, include electronic storage media, such as disks, for storing programming code and data structures used to implement the inventive method and outputs therefrom. The invention uses computer systems 104, 106, 108 and 110 to implement the invention described herein. Note, however, that any computer system may be configured to implement the inventive method and computer systems 104, 106, 108 and 110 are only used for exemplary purposes.

According to the invention, each of computer systems 104, 106, 108 or 110 includes a web browser that is used to view a self-directed, on-line reference tool. The on-line reference tool provides information to users by creating granular areas of content that are rapidly accessible through lookups, indices and links. Once the on-line reference tool is loaded in the web browser, the reference tool remains active so that users can look up information without exiting from a currently used application.

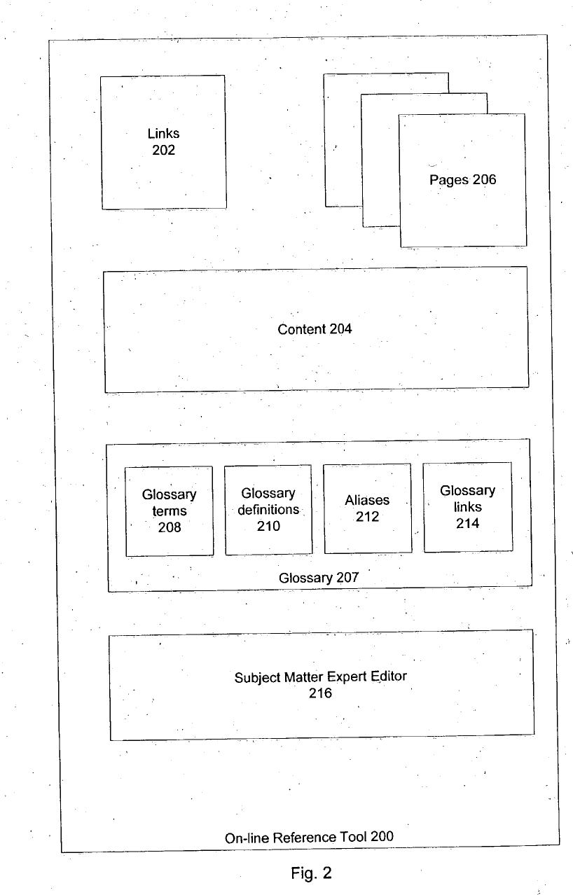

FIG. 2 illustrates the on-line reference tool 200, which includes a repository of links 202 between multiple pages 206 created from content 204, a glossary 207 with multiple glossary terms 208, definitions 210, aliases 212, and links 214 that connect glossary terms 208 to pages 206, and at least one subject matter expert editor 216. Content 204 is made up of materials from various sources and may include information that is related to one topic or to several unrelated topics. For example, content 204 may include information from research documents, presentations, and/or on-line courses. Each page 206 is a unit of information from content 204 that is presented to a user on a screen and that is related to a specific term. Information included in page 206 may include texts, formulas, animations, and/or interactive elements. Each glossary term 208 is a significant word or phrase, in content 204, that is associated with a given topic and each glossary definition 210 defines a specific glossary term 208. Each glossary alias 212 is an alternate name for a glossary term 208. For example, CAPEX may be used as an alias for “capital expenditure.” Each glossary link 214 links page 206 to an appropriate glossary term 208 and definition 210. After on-line reference tool 200 creates page 206 and links the appropriate glossary term 208 and definition 210 to page 206, expert editor 216 filters each linked term 208 and writes a question that corresponds to the linked term 208. Thereafter, on-line reference tool 200 uses related pages of information to answer questions created by expert editor 216. In one embodiment of the invention, expert editor 216 may be a user of on-line reference tool 200. In an alternate embodiment, expert editor 216 may be an automated component in on-line reference tool 200.

In the inventive system, content 204 must be structured. In a preferred embodiment of the invention, on-line reference tool 200 either receives content in a standard course format or structures content 204 in a standard course format and sequences information in content 204 from basic to complex. On-line reference tool 200 then breaks content 204 up into multiple pages 206, each of which focuses on a single subject or idea. Upon receiving content 204, on-line reference tool 200 extracts all glossary terms 208 and their corresponding glossary definitions 210 from content 204. Each glossary definition 210 is preferably no more than two sentences. On-line reference tool 200 then groups glossary terms 208 and definitions 210 in glossary 207.

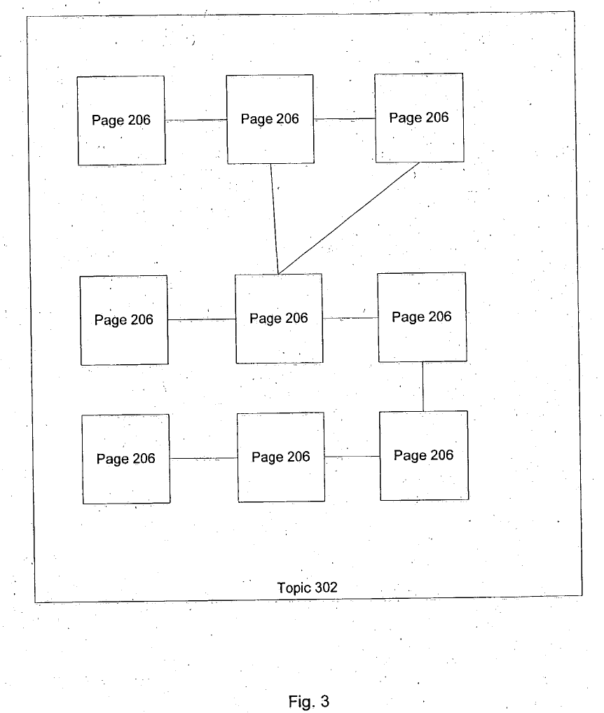

FIG. 3 illustrates how pages 206 from content 204 are structured. In the inventive system, each page 206 is a part of a topic 302. Topic 302 may include one or more related and/or unrelated pages 206 and the size of each topic 302 varies according to the amount of material covered by pages 206 in topic 302. Each page 206 in topic 302 teaches a specific concept and is also known as a teaching object. Upon creating topic 302, on-line reference tool 200 hyper-links various related teaching objects 206 within topic 302. On-line reference tool 200 also uses links 202 from the repository to link teaching objects 206 to glossary terms 208.

The structure of topic 302, i.e., the sequence or order of teaching objects 206, the sequence of courses or chapters of the original material and the appropriate categories to which the content belongs, is then stored in on-line reference tool 200. Thereafter, online reference tool 200 assigns a unique identifier to each teaching object 206 and uses the textual content of teaching object 206 to search for all relevant glossary terms 208 and aliases 212. The search preferably accommodates variations in plurals, tenses, and other grammatical elements. During the search, on-line reference tool 200 prevents inaccurate references to inappropriate terms, particularly terms that are broader than the search criterion. For example, if teaching object 206 includes the term “interest rate swap,” on-line reference tool 200 may retrieve information for “interest,” “rate,” interest rate,” and “interest rate swap.” However, on-line reference tool 200 will disregard all retrieved information that is not related to “interest rate swap.” This enables on-line reference tool 200 to eliminate retrieved information that is too broad and inappropriate. On-line reference tool 200 also uses glossary alias 212 for each glossary term 208 to search every page 206 in content 204. Thereafter, on-line reference tool 200 uses the teaching object identifier to produce a hyper-referencing table that links every glossary term 208 to the appropriate pages/teaching object 206.

Thereafter, subject matter expert editor 216 filters each reference created in the hyper-referencing table and writes a question that corresponds to the reference. Prior to writing a question for a reference, subject matter expert editor 216 selects each link in the hyper-referencing table and determines if a significant or relevant reference exists between a glossary term 208 and teaching object 206. If subject matter expert editor 216 determines that a significant or relevant reference exists, subject matter expert editor 216 writes a question that is answered by teaching object 206. If the reference is determined to be irrelevant, subject matter expert editor 216 marks the reference for removal from the hyper-referencing table. After writing questions for each relevant reference in the hyper-referencing table, on-line reference tool 200 stores a modified hyper-referencing table that includes the appropriate questions that were created by subject matter expert editor 216. Subject matter expert editor 216 then reviews all questions in the modified hyper-referencing table and the question sequence for every glossary term 208.

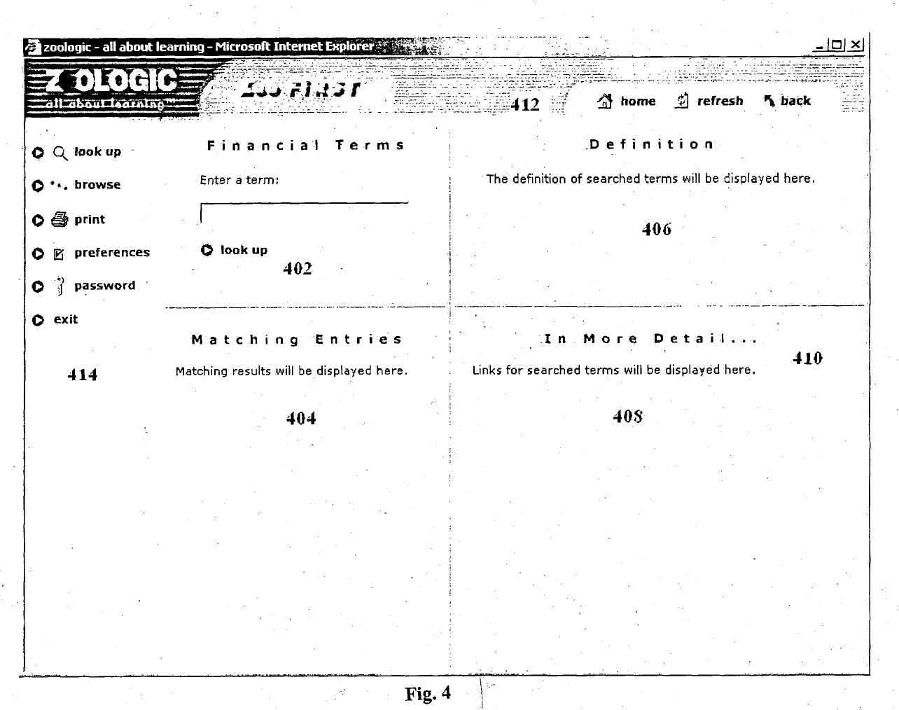

FIG. 4 illustrates an embodiment of tool 200 that is presented to a user. Upon loading up a browser and entering a URL that is associated with on-line reference tool 200, the user preferably registers with on-line reference tool 200 by providing a user identifier and password. Thereafter, the user enters a term in a lookup form 402. On-line reference tool 200 searches content 204 for the term entered by the user and produces a list of matching and/or related terms in a matching entries list 404. On-line reference tool 200 also displays a definition in a definition box 406 for each term that is selected in matching entries list 404. On-line reference tool 200 further provides a series of questions, in an in-more-detail list 408, that provides more in-depth knowledge about the selected term. The number of questions shown in in-more-detail list 408 is dependent on the selected term. If there are a large number of questions associated with the selected term, the user may use a filter 410 to limit the number of questions displayed. When the user accesses filter 410, a dialog window is presented to the user to enable the user to choose a category from a category menu. As is apparent to one skilled in the art, the dialog window may enable to the user to select various categories and sub-categories from the category menu. After the user selects the appropriate category, on-line reference tool 200 closes the filter window and updates in-more-detail list 408 with only those questions from the selected category. On-line reference tool 200 also includes a navigation bar 412 for allowing the user to navigate through the tool and a tool bar 414 for allowing access to other elements in on-line reference tool 200, such as an element that allows the user to view all available terms in the system.

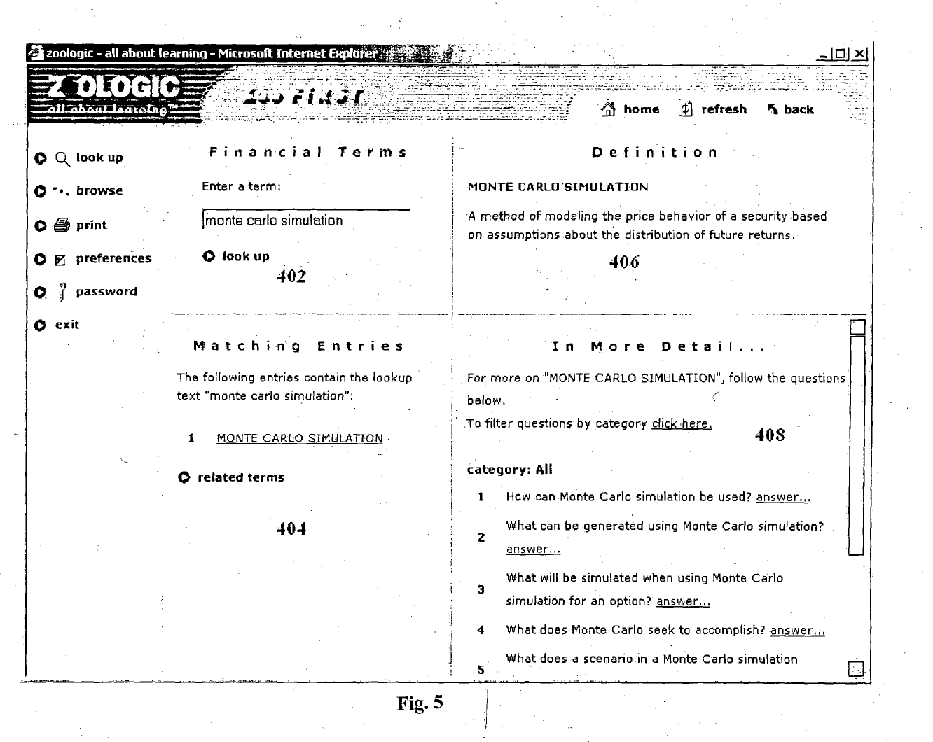

FIG. 5 illustrates an example of how the elements in FIG. 4 are implemented. Upon loading on-line reference tool 200, the user enters “Monte Carlo Simulation” in lookup form 402. On-line reference tool 200 searches content 204 for all teaching objects 302, glossary terms 208, glossary definitions 210, aliases 212, and questions that are related to “Monte Carlo Simulation.” If an exact match is found for the user requested term, on-line reference tool 200 produces the match in matching entries list 404 and automatically selects the matching term. If an exact match is not found for the user requested term, on-line reference tool 200 produces a list of matching terms in matching entries list 404. When a term in matching entries list 404 is selected either automatically by on-line reference tool 200 or manually by the user, on-line reference tool 200 provides a definition in definition box 406 and a series of questions in in-more-detail list 408.

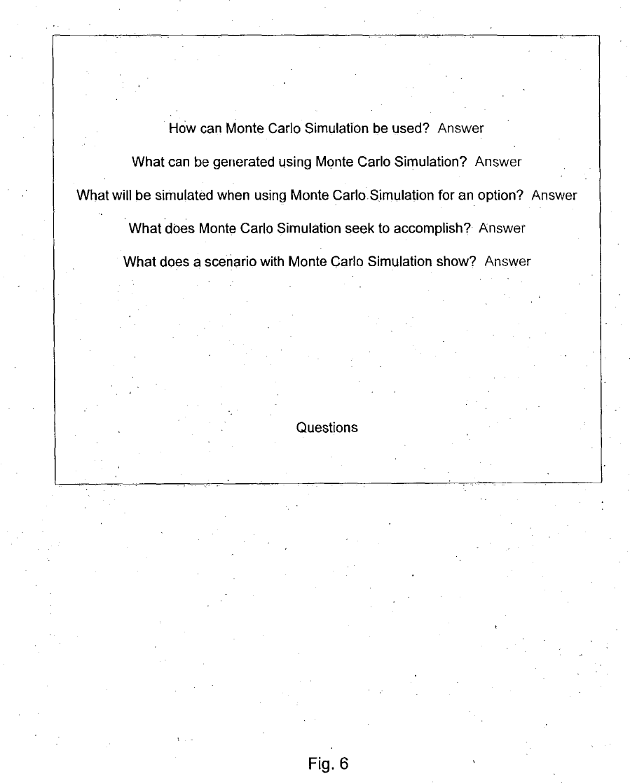

FIG. 6 illustrates examples of questions that may be produced by on-line reference tool 200 for the “Monte Carlo simulation” term. To obtain the answer to a question, the user clicks on the answer hyperlink at the end of the question. It should be apparent to one of ordinary skill in the art, that other methods may be used to link to the answer of a question. When the user selects the answer link for a question, on-line reference tool 200 changes the interface presented to the user and displays page 206 that contains the answer within a specific context. On-line reference tool 200 preferably displays the list of question above answer page 206 and highlights the selected question. The user is allowed to scroll down the list of questions and select another question by clicking on the associated answer link. On-line reference tool 200 automatically updates answer page 206 when a new question is selected. Answer page 206 for a question may include animations, interactive equations, what-if simulations, hyper-links to other pages and pop ups. As is apparent to one skilled in the art, answer page 206 may include other means for presenting information to the user. As the user follows links from various questions, on-line reference tool 200 enables the user to trace back by using a back button on navigation bar 414. On-line reference tool 200 further includes a learn more button that allows the user to access resources, such as courses, that are related to the content of displayed page 206. On-line reference tool 200 also track the user's inquiries, search texts, and teaching object navigation to enhance future searches. The inventive tool ultimately provides a self-directed, self paced access to knowledge that is most desirable to users.

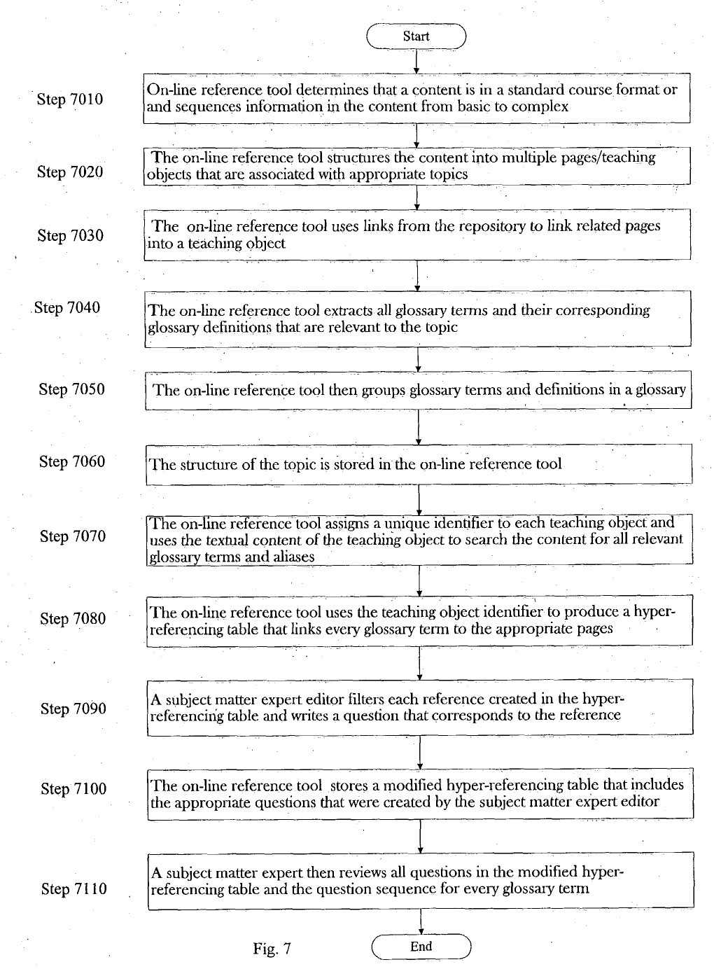

FIG. 7 illustrates the steps implemented in the inventive system. In Step 7010, on-line reference tool 200 determines that content 204 is in a standard course format and sequences information in content 204 from basic to complex. In Step 7020, on-line reference tool 200 structures content 204 into multiple pages/teaching objects 206 that are associated with appropriate topics 302. In Step 7030, on-line reference tool 200 uses links 202 from the repository to link related teaching objects 206. In Step 7040, on-line reference tool 200 extracts all glossary terms 208 and their corresponding glossary definitions 210 that are relevant to topic 302 from content 204. In Step 7050, on-line reference tool 200 then groups glossary terms 208 and definitions 210 in glossary 207. In Step 7060, the structure of topic 302 is stored in on-line reference tool 200. In Step 7070, on-line reference tool 200 assigns a unique identifier to each teaching object/page 206 and uses the textual content of teaching object 206 to search content 204 for all relevant glossary terms 208 and aliases 212.

In Step 7080, on-line reference tool 200 uses the teaching object identifier to produce a hyper-referencing table that links every glossary term 208 to the appropriate pages 206. In Step 7090, subject matter expert editor 216 filters each reference created in the hyper-referencing table and writes a question that corresponds to the reference. In Step 7100, on-line reference tool 200, stores a modified hyper-referencing table that includes the appropriate questions that were created by subject matter expert editor 216. In Step 7110, subject matter expert editor 216 then reviews all questions in the modified hyper-referencing table and the question sequence for every glossary term 208.

The foregoing description has been directed to specific embodiments of this invention. It will be apparent, however, that other variations and modifications may be made to the described embodiments, with the attainment of some or all of their advantages. Therefore, it is the object of the appended claims to cover all such variations and modifications as come within the true spirit and scope of the invention.

What is claimed:

1. A system for quickly retrieving information that is related to a specific topic, the system comprises:
a plurality of processing components, wherein at least one of the plurality of processing components is an on-line reference tool having a plurality of components and information that is structured into multiple units such that each unit teaches a specific subject and is associated with a specific topic, the on-line reference tool links related units of information to glossary terms and writes at least one question that corresponds to each link, wherein when a user selects a question, at least one unit of information is presented to the user; and
means for viewing information presented by on-line reference tool.

2. The system of claim 1, wherein the on-line reference tool comprises:
a repository of links to a content;
the content having information from at least one source, information in the content being structured in a plurality of pages each of which is a unit of information that is related to a specific topic;
a glossary with a plurality of glossary terms each of which is associated with a given subject, a plurality of glossary definitions each of which defines a specific glossary term, a plurality of glossary aliases each of which is an alternate name for a specific glossary term, and a plurality of glossary links each of which links a specific page to an appropriate glossary term and glossary definition; and
at least one subject matter expert editor that filters each linked glossary term and writes a question that corresponds to the linked glossary term, wherein when the user selects the question the system presents at least one page that is associated with the linked glossary term.

3. The system of claim 2, wherein the content is structured in a standard course format and sequenced from basic to complex.

4. The system of claim 2, wherein each page is a teaching object that teaches a specific concept and wherein upon creating each teaching object the structure of the teaching object is stored, a unique identifier is assigned to the teaching object, the textual content of the teaching object is used to search for all relevant glossary terms and glossary aliases, and a teaching object identifier is used to produce a hyper-referencing table that links every glossary term to an appropriate page.

5. The system of claim 4, wherein all glossary terms and their corresponding definitions that are related to the specific topic are extracted from the content and stored in the glossary.

6. The system of claim 4, wherein the subject matter expert editor filters each reference in the hyper-referencing table and writes a question that corresponds to the reference.

7. The system of claim 6, wherein the subject matter expert editor filters each reference by selecting each link in the hyper-referencing table and determining that a significant reference exists between the glossary term and the teaching object.

8. The system of claim 6, wherein the subject matter expert editor filters each reference by selecting each link in the hyper-referencing table and marking for removal those references that are determined to be irrelevant.

9. The system of claim 6, wherein a modified hyper-referencing table that includes questions created by the subject matter expert editor is stored and the subject matter expert editor reviews all questions in the modified hyper-referencing table and question sequence for every glossary term in the modified hyper-referencing table.

10. An on-line reference tool for quickly retrieving information that is related to a specific topic, the on-line reference tool comprises:
a repository of links to a content;
the content having information from at least one source, information in the content is structured in a plurality of pages each of which is a unit of information that is related to a specific term;
a plurality of topics each of which includes a plurality of hyper-linked pages each of which teaches a specific concept;
a glossary with a plurality of glossary terms that are associated with a given topic, a plurality of glossary definitions each of which defines a specific glossary term, a plurality of glossary aliases each of which is an alternate name for a specific glossary term, and a plurality of glossary links each of which links a page to an appropriate glossary term and glossary definition; and
at least one subject matter expert editor that filters each linked glossary term and writes a question that corresponds to the linked glossary term, wherein when the user selects the question the system presents at least one page that is associated with the linked glossary term.

11. An on-line reference tool for quickly presenting information that is related to a specific topic to a user, the on-line reference tool comprises:
means for allowing the user to enter a term in a lookup form;
means for searching a content for the term and producing a list of terms, at least one definition for each term, and at least one question for each term that is linked to a teaching object;
means for enabling the user to select one term from the list of terms and a question and an associated answer; and
means for displaying a unit of information that contains the associated answer.

12. The on-line reference tool of claim 11, wherein when searching for the term, if the on-line reference tool finds an exact match, the on-line reference tool produces only the match in the list of related terms, automatically selects the match and produces the associated definition and questions.

13. The on-line reference tool of claim 11, wherein the user is allowed to filter the number of questions produced for each term and the on-line reference tool presents only those questions in a category that is selected by the user.

14. The on-line reference tool of claim 11, further comprising means for enabling the user to navigate through the on-line reference tool.

15. The on-line reference tool of claim 11, wherein the user is allowed to scroll down a list of questions and select a question, wherein the on-line reference tool automatically displays the answer for each selected question.

16. A method for structuring information that is related to a specific topic so that the structured information can be rapidly presented to a user, the method comprises the steps of:
determining that a content is in a standard course format and sequencing information in the content from basic to complex;
extracting all glossary terms, associated definitions, and aliases that are relevant to a specific concept from the content;
breaking up the content into multiple teaching objects, each of which teaches a concept and is associated with a specific topic;
storing the structure of each topic and assigning a unique identifier to the teaching objects associated with the topic;
using the concept of the teaching object to search the content for all relevant glossary terms and aliases;
using the teaching object identifier to produce a hyper-referencing table that links every glossary term to an appropriate page;
filtering each reference in the hyper-referencing table and writing a corresponding question for the reference; and
storing a modified hyper-referencing table that includes at least one corresponding question, wherein when the user selects a question that is related to a specific term, the appropriate page is presented to the user.

17. The method of claim 16, wherein the step of extracting all glossary terms further comprises the step of grouping the glossary terms, associated definitions and aliases in a glossary.

18. A method for rapidly presenting structured information that is related to a specific topic to a user, the method comprises the steps of:
determining that a content is in a standard course format and sequencing information in the content from basic to complex;
extracting all glossary terms, associated definitions, and aliases that are relevant to a specific concept from the content;
breaking up the content into multiple teaching objects, each of which teaches a concept and is associated with a specific topic;
storing the structure of each topic and assigning a unique identifier to the teaching objects associated with the topic;
using the concept of the teaching object to search the content for all relevant glossary terms and aliases;
using the teaching object identifier to produce a hyper-referencing table that links every glossary term to an appropriate page;
filtering each reference in the hyper-referencing table and writing a corresponding question for the reference;
storing a modified hyper-referencing table that includes at least one corresponding question;
allowing the user to enter a term in a lookup form;
searching the content for the term and producing a list of terms, at least one definition for each term, and at least one question for each term that is linked to a teaching object; and
selecting one term from the list of terms and a question and an associated answer, wherein the associated answer displays information in the appropriate page that is linked to the selected term.

19. The method of claim 18, further comprising the step of filtering the number of questions produced for each term and presenting only those questions in a category that is selected by the user.

20. A computer-readable medium whose contents cause a computer system to rapidly present structured information that is related to a specific topic to a user, by performing the steps of:
determining that a content is in a standard course format and sequencing information in the content from basic to complex;
extracting all glossary terms, associated definitions, and aliases that are relevant to a specific concept from the content;
breaking up the content into multiple teaching objects, each of which teaches a concept and is associated with a specific topic;
storing the structure of each topic and assigning a unique identifier to the teaching objects associated with the topic;
using the concept of the teaching object to search the content for all relevant glossary terms and aliases;
using the teaching object identifier to produce a hyper-referencing table that links every glossary term to an appropriate page;
filtering each reference in the hyper-referencing table and writing a corresponding question for the reference;
storing a modified hyper-referencing table that includes at least one corresponding question;
allowing the user to enter a term in a lookup form;
searching the content for the term and producing a list of terms, at least one definition for each term, and at least one question for each term that is linked to a teaching object; and
selecting one term from the list of terms and a question and an associated answer, wherein the associated answer displays information in the appropriate page that is linked to the selected term.

21. An on-line reference tool for quickly retrieving information that is related to a specific topic, the on-line reference tool comprises:
a repository of links to a content;
the content having information from at least one source, information in the content is structured in a plurality of pages each of which is a unit of information that is related to a specific term;
a plurality of topics each of which includes a plurality of hyper-linked pages each of which teaches a specific concept;
a glossary with a plurality of glossary terms that are associated with a given topic, a plurality of glossary definitions each of which defines a specific glossary term, a plurality of glossary aliases each of which is an alternate name for a specific glossary term, and a plurality of glossary links each of which links a page to an appropriate glossary term and glossary definition; and
means for filtering each linked glossary term and writing a question that corresponds to the linked glossary term, wherein when the user selects the question the system presents at least one page that is associated with the linked glossary term.
